(19) United States
(12) Patent Application Publication
(10) Pub. No.: US 2012/0127570 A1
(43) Pub. Date: May 24, 2012

(54) AUTO-STEREOSCOPIC DISPLAY

(75) Inventors: Hideyuki Sakai, Yokohama (JP); Masami Yamasaki, Sagamihara (JP)

(73) Assignee: Hitachi, Ltd.

(21) Appl. No.: 13/120,893

(22) PCT Filed: Oct. 6, 2009
(86) PCT No.: PCT/JP2009/005184

§ 371 Date: Jun. 10, 2011

(30) Foreign Application Priority Data
Nov. 19, 2008 (JP) 2008-295430

(51) Int. Cl. G02B 27/22

(52) U.S. Cl. 359/463

(57) ABSTRACT

An auto-stereoscopic display is provided with a plurality of projectors, a micro-lens array for collecting the light beams of the images projected from the projectors, and a diffuser for diffusing the beams collected by the micro-lens array. The diffuser has the diffusion angle corresponding to the distance from the micro-lens array. Furthermore, the diffuser is arranged so as to form a virtual beam collecting point between a plurality of collecting points of the light beams formed by a plurality of micro-lenses constituting the micro-lens array.

### BACKGROUND OF THE INVENTION

The present invention relates to a display for displaying stereoscopic images that can be stereoscopically viewed by the naked eye.

In recent years, as a tendency to enhance the added value of displays, the market for the stereoscopic display for displaying stereoscopic images has been vitalized. Also, there has been actively developed the auto-stereoscopic display for displaying the stereoscopic images that can be observed by the naked eye without the use of devices such as polarized glasses. As a technique for realizing the auto-stereoscopic vision, there is an integral photography method (hereinafter referred to as “IP method”) disclosed in M. G. Lippmann, “Epreuves reversibles donnant la sensation du relief,” J. de Phys., vol. 7, 4th series, pp. 821-825, November 1908. The IP method is a technique for reproducing stereoscopic vision in both horizontal and vertical directions.

The stereoscopic display based on the IP method allows an improvement in the performance of the stereoscopic display. For example, the more the number of controllable light beams passing through each of micro-lenses constituting a micro-lens array used in the IP method, the more an observable range of the stereoscopic image to be displayed can be designed to expand, and it is possible to realize a smooth change in the stereoscopic image in response to the change of the viewpoint due to an increase in the number of the controllable light beams included in a unit viewing angle range.

In the case of applying a flat display, such as a liquid crystal display or a plasma display, which is an existing two-dimensional display device, to the IP method, it is necessary to use the flat display with as high the pixel arrangement density as possible to increase the number of the controllable light beams. However, at present there is not enough pixel density in the producible two-dimensional display devices to sufficiently ensure the number of the light beams per micro-lens.

On the other hand, JP-A No. 2003-279894 discloses a technique in which the images of plural projectors are densely-projected in a tiled manner so as to improve resolution of a two-dimensional image that is displayed at the back of a micro-lens array, thereby producing high-resolution two-dimensional images that cannot be achieved by existing devices, and improving the number of pixels of the two-dimensional image covered per micro-lens. Additionally, JP-A No. 2008-139524 discloses a technique for increasing the number of the controllable light beams passing through each micro-lens by superimposing the images of multiple projectors.

### SUMMARY OF THE INVENTION

The technique disclosed in JP-A No. 2003-279894 is designed to address problems caused by the manufacturing limitations of the two-dimensional display device, by arranging the images of the multiple projectors in a tiled manner. However, an expensive high-resolution projector lens is necessary to project a high-resolution image at a short distance, and there are optical manufacturing limitations with respect to a diffusing screen that is placed in an in-focus plane to form a pixel image.

The technique disclosed in JP-A No. 2008-139524 is designed to address problems caused by the manufacturing limitations of the two-dimensional display device, by superimposing the images of multiple projectors, and also allows a scalable change in the resolution and stereoscopic effect of stereoscopic images by changing the number of the projectors. Although this technique requires compact projectors, the markets for small projectors and laser projectors for use in cellular phones or the like have been formed in recent years, and therefore there is no need to see hardware manufacturing limitations as problems compared with the technique disclosed in JP-A No. 2003-279894. However, the stereoscopic image according to this technique has problems with the image quality that the stereoscopic image surface is perceived to be grainy and lacks smoothness.

Here, the technique disclosed in JP-A No. 2008-139524 will be briefly described. FIGS. 1 and 2 are schematic diagrams of one embodiment of JP-A No. 2008-139524, where reference numeral 1 denotes a projector and nine projectors are vertically and horizontally arranged. A micro-lens array 2 is an array of micro-lenses and is placed between the projectors and an observer. In place of this micro-lens array, as shown in FIG. 2, a superimposed lenticular lens composed of a horizontal lenticular lens 20 and a vertical lenticular lens 21 may be used. This structure enables an observer to observe a stereoscopic image by projecting an appropriate image from each projector, controlling a corresponding light beam of the projector with each micro-lens of the lens array, and guiding appropriate light beams 5 and 6 to observer's right and left eyes 3 and 4, respectively.

At this time, the light beams around the lens array are roughly as shown in FIG. 3. In this figure, with three projectors, a light beam group parallel to a light beam 302a, a light beam group parallel to a light beam 303a, and a light beam group parallel to a light beam 304a are incident on the lens array 2. Strictly speaking, in order to allow the parallel light beams to enter the lens array 2, it is necessary to place a light beam control system, such as a Fresnel lens, before the lens array 2. However, such a system is not described herein, and the respective light beams are considered as roughly parallel. At this time, for example, the light beams 302a, 302b, and 302c are condensed onto a point 302 through a micro-lens of the lens array 2 and then spreads out into different directions. In the same manner, for example, the light beams 303a, 303b, and 303c are condensed onto a point 303, and the light beams 304a, 304b, and 304c are condensed onto a point 304. Thus an observer 300 sees the light beams spreading from the light condensing points arranged in a range 301. However, the light condensing points are discretely-distributed as shown in the figure, and therefore the stereoscopic image is perceived to be grainy in image quality. It should be noted that although the discretely-distributed light condensing points can be thickened by increasing the number of the projectors to increase the number of the light condensing points in the range 301, there are physical limitations on the size and installation location of the projectors themselves, and the cost increases.

An auto-stereoscopic display according to the present invention includes: a plurality of projectors; a micro-lens array for condensing light beams of images projected from the projectors; and a diffuser for diffusing the light beams condensed by the micro-lens array.

According to another preferable aspect of the present invention, the diffuser has a diffusion angle corresponding to a distance from the micro-lens array.

According to still another preferable aspect of the present invention, the diffuser is arranged so as to form a virtual light condensing point between a plurality of condensing points of the light beams condensed by a plurality of micro-lenses constituting the micro-lens array.

### EFFECTS OF INVENTION

The diffuser is placed between the micro-lens array and the observer, thereby providing the effect of interpolating light beams incident on an observer's eye to allow a smooth stereoscopic image to be perceived.

### BRIEF DESCRIPTION OF THE DRAWINGS

FIG. 1 is a diagram for explaining an auto-stereoscopic display according to the related art.

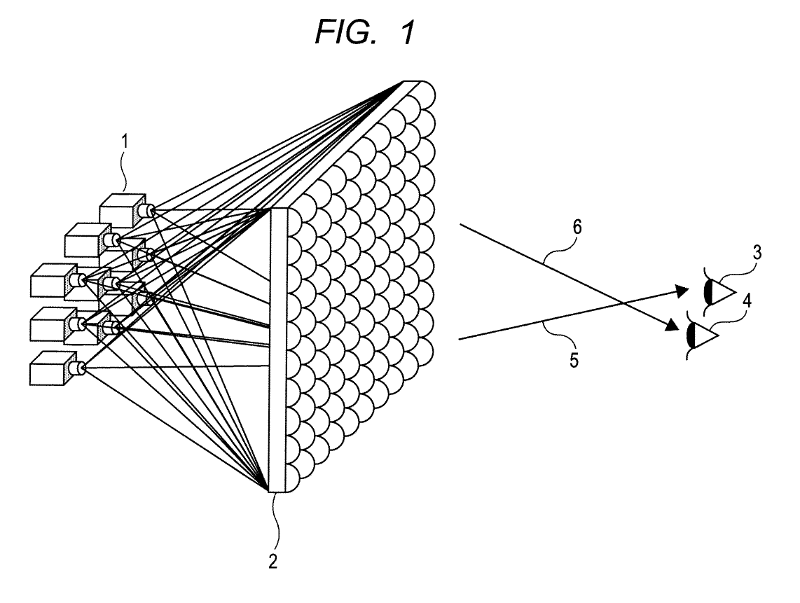

FIG. 2 is a diagram with a micro-lens array replaced with a lenticular lens in the auto-stereoscopic display according to the related art.

FIG. 3 is a diagram for explaining the behavior of light beam groups passing through the micro-lens array in the auto-stereoscopic display according to the related art.

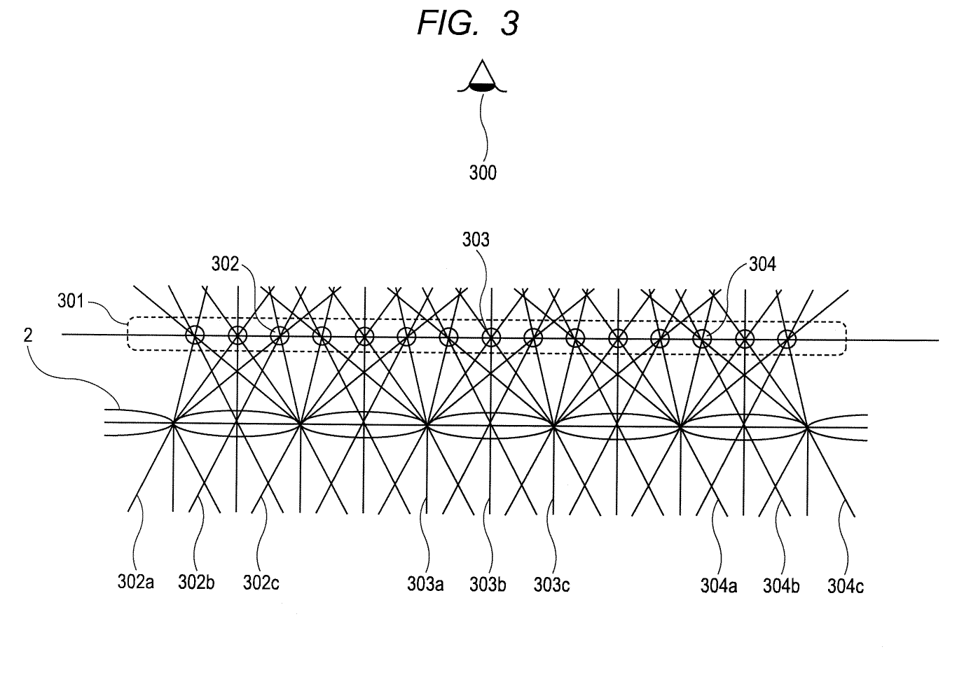

FIG. 4 is a diagram for explaining an auto-stereoscopic display with a Fresnel lens added.

FIG. 5 is a sectional view, in a horizontal plane passing through the center of the Fresnel lens 7, of the device of FIG. 4.

FIG. 6 is a diagram for explaining luminous fluxes projected by a projector.

FIG. 7 is a diagram for explaining the behavior of luminous fluxes perpendicularly incident on the Fresnel lens.

FIG. 8 is a diagram for explaining the behavior of luminous fluxes incident at an angle on the Fresnel lens.

FIG. 9 is a diagram for explaining the behaviors of the light beam groups and light condensing points of projection images of plural projectors.

FIG. 10 is a diagram for showing the distribution of the light condensing points over the micro-lens array.

FIG. 11 is a diagram for explaining the behavior of the light beams incident on an observer's pupil.

FIG. 12 is a diagram for explaining the auto-stereoscopic display.

FIG. 13 is a diagram for explaining the interpolation of luminous flux groups.

FIG. 14 is a diagram for explaining a diffusion angle of a diffuser in the case of producing the luminous flux group from a virtual light condensing point for forming an interpolation image on the retina.

FIG. 15 is a diagram for explaining a diffusion angle of a diffuser in the case of producing the luminous flux group from a virtual light condensing point for forming an interpolation image on the retina.

FIG. 16 is an extreme example in the case of performing the image interpolation.

### DESCRIPTION OF THE EMBODIMENTS

Hereinafter, an embodiment of the present invention will be described. In the respective drawings, the same components are designated by the same reference signs.

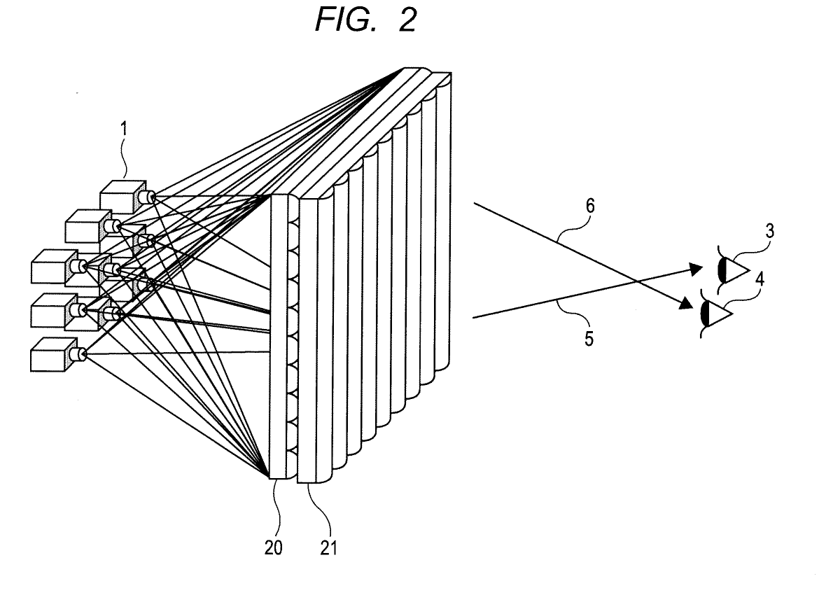

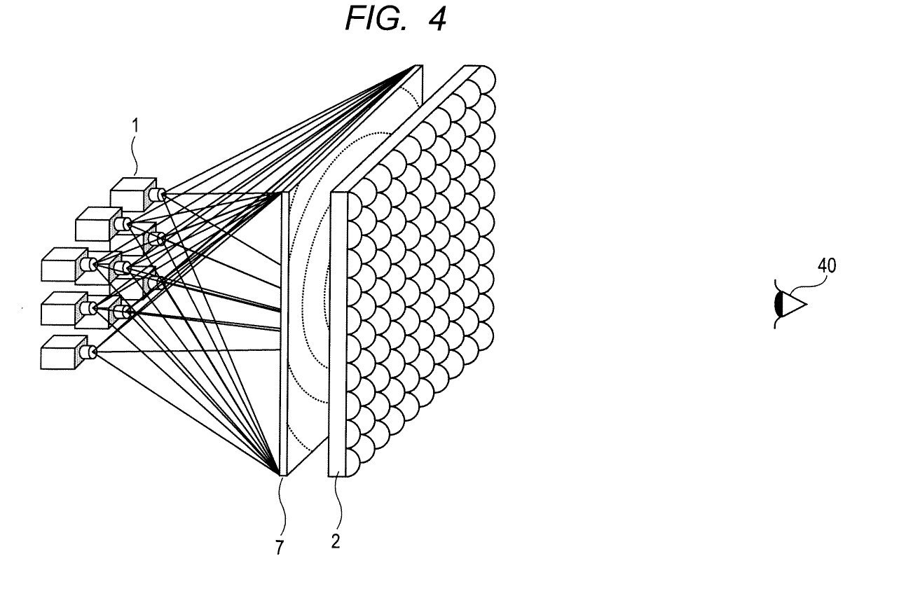

FIG. 4 shows the device configuration of an auto-stereoscopic display with a Fresnel lens 7 added. The characteristics of light beams forming a stereoscopic image to be produced will be described using FIG. 4. It should be noted that, in this embodiment, a total of nine projectors 1 are arranged vertically and horizontally, however, with respect to the number and arrangement of the projectors, other configurations may be used. The Fresnel lens 7 provides an optical function equivalent to a convex lens, and is disposed in such a manner that a Fresnel lens surface corresponds to a focused plane of projection images from the projectors 1. A micro-lens array 2 is placed across the Fresnel lens 7 from the side on which the projectors are placed, and disposed parallel to the Fresnel lens 7. It should be noted that, in this embodiment, a description is given by using the Fresnel lens 7, however, an optical system, such as a single convex lens, having the optical property equivalent to the Fresnel lens, may be used. Alternatively, as for the micro-lens array, an optical system with the lenticular lenses placed in an intersecting manner as shown in FIG. 2 may be used. An observer 40 sees the light beams projected from the nine projectors through the Fresnel lens 7 and the micro-lens array 2, thereby observing a stereoscopic image.

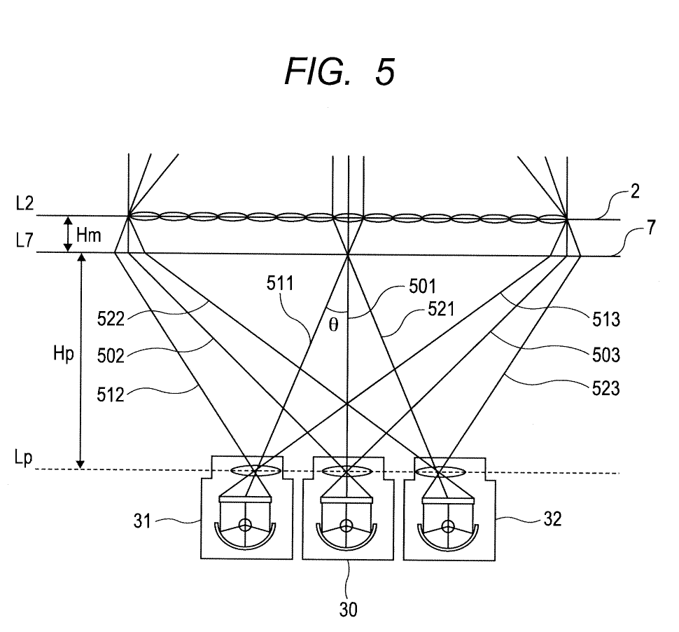

FIG. 5 is a sectional view, in a horizontal plane passing through the center of the Fresnel lens 7, of the device of FIG. 4. The micro-lens array 2 and the Fresnel lens 7 are arranged in parallel. The three projectors 30, 31, and 32 located in section are arranged parallel to the surface of the Fresnel lens 7, and the projector lens center of the respective projectors is in the same plane Lp. A plane passing through the lens center of the Fresnel lens 7, parallel to the Fresnel lens 7, is denoted by L7, and a plane passing through the lens center of the respective micro-lenses forming the micro-lens array 2 is denoted by L2. Also, the focal length of the respective micro-lenses forming the micro-lens array 2 is denoted by f2, and the focal length of the Fresnel lens 7 is denoted by f7. In addition, the distance between the plane L2 and the plane L7 is denoted by Hm, and the distance between the plane L7 and the plane Lp is denoted by Hp. It should be noted that Hp and f7 are made equal and Hm and f2 are made equal. It also should be noted that, in this figure, only the principal rays of the respective light beams are illustrated.

At this time, when an image is projected from the projector 30 in a symmetrical manner about the center of the Fresnel lens 7 and the micro-lens array 2, a central principal ray 501 of the projection image of the projector 30 enters perpendicularly the lens center of the Fresnel lens 7 and passes perpendicularly as it is to enter the micro-lens array 2. A left principal ray 502 and a right principal ray 503 of the projection image of the projector 30 each enter the Fresnel lens 7 at an angle, however, by the lens effect, exit perpendicularly from the surface of the Fresnel lens 7 to enter perpendicularly the micro-lens array 2. In other words, the principal rays of the respective pixels of the projection image of the projector 30 are guided to the micro-lens array 2, as a parallel light beam group perpendicular to the lens surface of the Fresnel lens 7.

As for the projector 31, the projection position is adjusted so that a central principal ray 511 of the projection image of the projector 31 enters the lens center of the Fresnel lens 7 at an angle θ. The principal ray 511 passes through the lens center of the Fresnel lens 7, and therefore exits from the Fresnel lens 7 at the same angle θ as the incidence angle θ to enter the micro-lens array 2. A left principal ray 512 and a right principal ray 513 of the projection image of the projector 31 each exit from the surface of the Fresnel lens 7 at the angle θ by the lens effect to enter the micro-lens array 2. In other words, the principal rays of the respective pixels of the projection image of the projector 31 are guided to the micro-lens array 2, as a parallel light beam group with the angle θ, from the lens surface of the Fresnel lens 7.

The projector 32 is placed at a position symmetric to the projector 31 with respect to the projector 30. Therefore, principal rays 521, 522, 523 of the respective pixels of the projection image are symmetric to those of the projector 31.

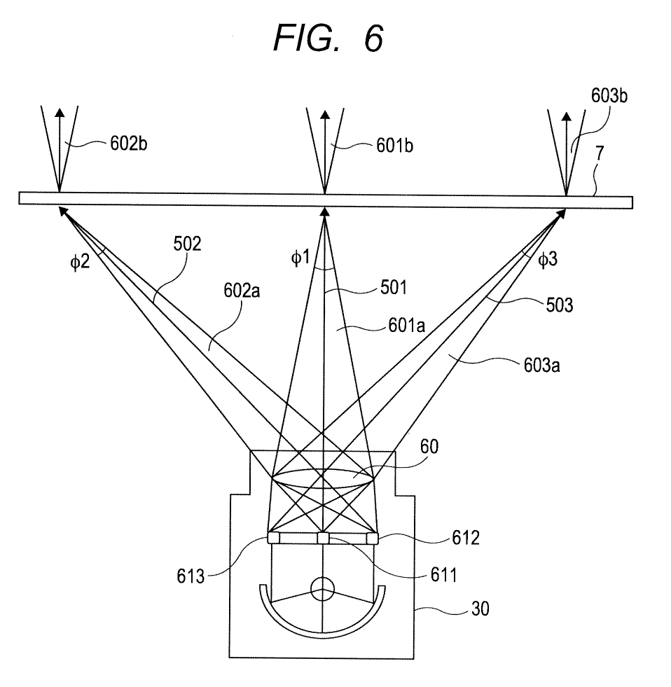

Referring to FIGS. 6 to 8, the positional relationship between incident and exit rays of the projection images of the projectors 30 and 31 upon and from a micro-lens constituting the micro-lens array 2 will be described. Here, for a more accurate understanding of the behavior of the light beams, the light beams emitted from the whole projection lens of each projector are defined as a luminous flux.

Firstly, referring to FIG. 6, the luminous flux from the projector will be described. First of all, the luminous flux emitted from a central portion of a central pixel 611 of the projector 30 will be described. The principal ray emitted from the central portion of the pixel 611 is 501. The luminous flux emitted from the central portion of the pixel 611 by a diffuse light source of the projector converges as a luminous flux 601a through a projection lens 60 and enters the Fresnel lens 7 at an angle φ1 to exit as a luminous flux 601b by the lens effect. Next, the luminous flux emitted from a right end of a right pixel 612 of the projector 30 will be described. The principal ray emitted from the right end of the pixel 612 is 502. The luminous flux emitted from the right end of the pixel 612 by the diffuse light source of the projector converges as a luminous flux 602a through the projection lens 60 and enters the Fresnel lens 7 at an angle φ2 to exit as a luminous flux 602b by the lens effect. As for the luminous flux emitted from a left end of a left pixel 613 of the projector 30, the principal ray is denoted by 503; a convergent luminous flux, 603a; an incidence angle φ3 on the Fresnel lens 7; and an exit luminous flux 603b. The convergent angles φ1, φ2, and φ3 of the luminous fluxes increase with increasing the projection lens aperture.

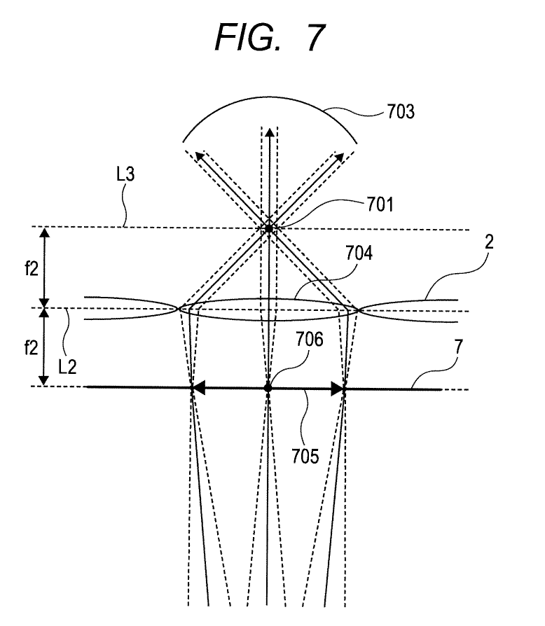

The behavior of a luminous flux group projected from the projector 30 onto a micro-lens 704 at the center of the micro-lens array 2 will be described by using FIG. 7. There is shown the case where the micro-lens 704 is located in such a manner that the optical axis passes perpendicularly through a center 706 of the Fresnel lens 7. The projector 30 performs the projection as described in FIG. 5. The luminous flux group entering an area 705 of the Fresnel lens 7 from the projector 30 exits while spreading out perpendicularly by the lens effect, and enters the micro-lens 704, and then exits through a light condensing point 701 as respective parallel luminous fluxes by the lens effect. Actually, the luminous fluxes from the projector 30 are densely incident on the area 705. The dense luminous fluxes enter the micro-lens 704 to spread densely over a conical area of a range 703 from the light condensing point 701. The size of the light condensing point depends on the aperture and angle of field of the projector and the focal length of the micro-lens. The conically spreading luminous flux group includes as many different luminous fluxes as the number of the pixels corresponding to the micro-lens, which are arranged according to arrangement of the pixels.

It should be noted that, in FIG. 7, the distance between the plane L2 passing through the lens center of each of the micro-lenses forming the micro-lens array 2 and the Fresnel lens 7 equals, in the same manner as FIG. 5, to the focal length f2 (equal to Hm) of each micro-lens. The light condensing point 701 by each micro-lens is formed on a plane L3 at a distance of the focal length f2 from the plane L2.

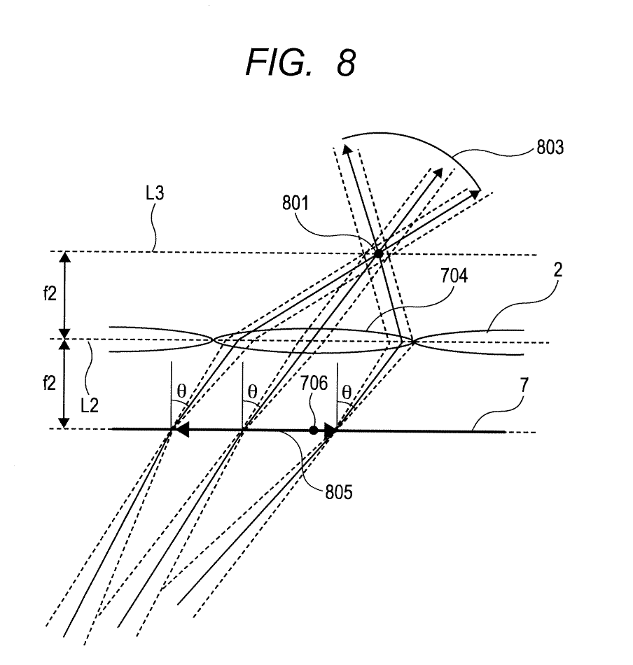

The behavior of a luminous flux group projected from the projector 31 onto the micro-lens 704 at the center of the micro-lens array 2 will be described by using FIG. 8. Note that the projector 31 performs the projection as described in FIG. 5. The luminous flux group entering an area 805 of the Fresnel lens 7 from the projector 31 exits while spreading out in a direction of the angle θ by the lens effect, and enters the micro-lens 704, and then exits through a light condensing point 801 as respective parallel luminous fluxes by the lens effect. Actually, in the same manner as the case of FIG. 7, the luminous fluxes spread densely over a conical area of a range 803 from the light condensing point 801.

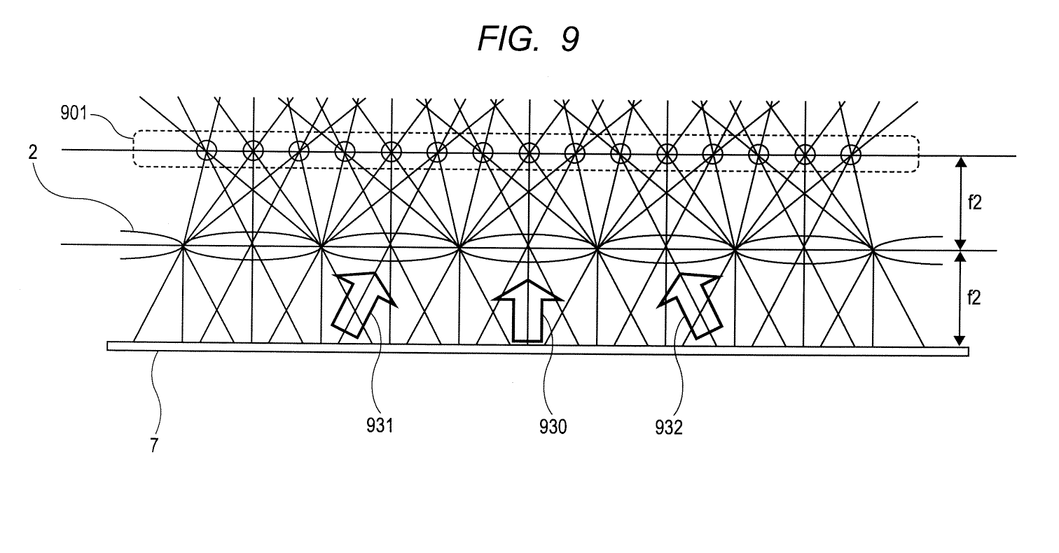

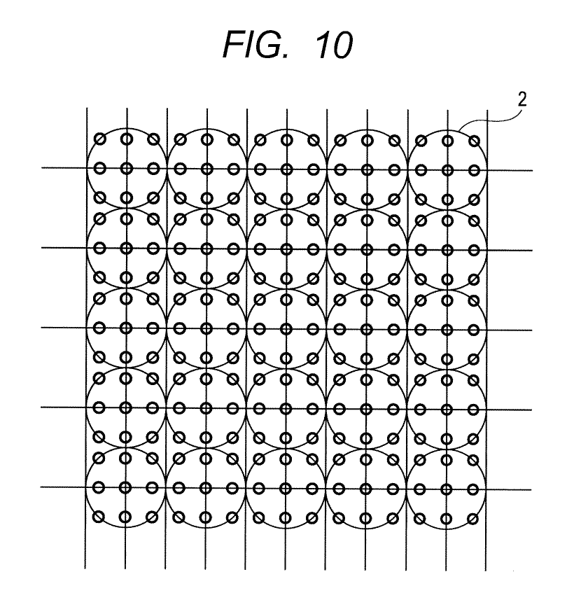

FIG. 9 illustrates together the behaviors of the light beam groups and light condensing points of the three projectors 30, 31, and 32. In a direction 930 from the projector 30, in a direction 931 from the projector 31, and in a direction 932 from the projector 32, the respective light beam groups are incident on the micro-lens array 2 from the Fresnel lens 7. These light beams pass through respective micro-lenses of the micro lens array 2 to spread out through the light condensing points corresponding to the three projectors. These light condensing points are arranged in a range 901, and, when viewed from the observer, the light condensing points (small circles in the figure) are distributed over the micro-lens array 2 as shown in FIG. 10. In this manner, there are formed nine light condensing points per micro-lens (a bigger circle in the figure), corresponding to the number of nine projectors. Also, the conical light beam groups corresponding to the pixels of portions to enter each micro-lens of the projection images of the respective projectors exit from each of the light condensing points. Thus, the number of the light condensing points per micro-lens increases with an increase in the number of the projectors, and the number of the controllable light beams per micro-lens also increases, thereby enhancing the image quality of a stereoscopic image and realizing scalability.

Hereinafter, there will be described the reasons that the stereoscopic images of the auto-stereoscopic display described in FIGS. 4 to 10 are grainy (lacks smoothness), and the solution to the problem.

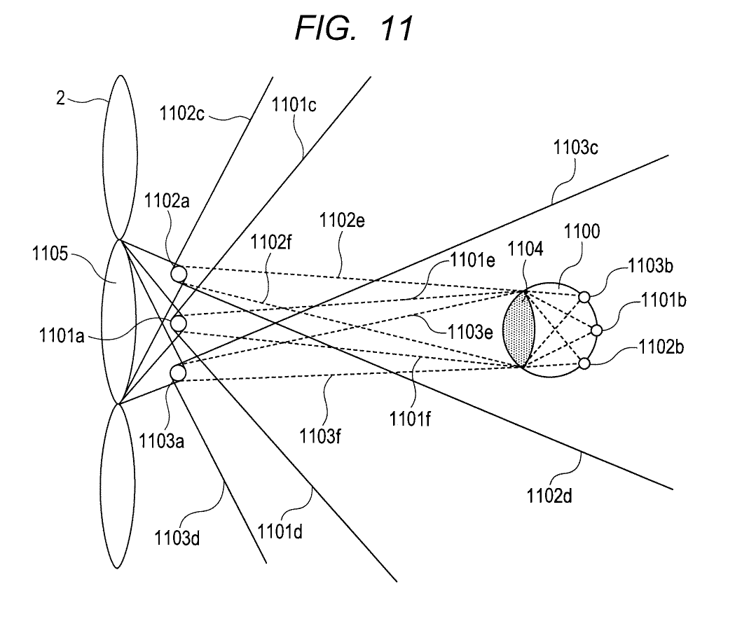

FIG. 11 illustrates the behavior of the light beams incident on a pupil 1104 of an observer's eyeball 1100. A description will be provided by using three points 1101a, 1102a, and 1103a of the nine light condensing points formed with respect to a micro-lens 1105 of the micro-lens array 2. A conical luminous flux group shown by solid lines 1101c and 1101d spreads from the light condensing point 1101a, of which a conical luminous flux group shown by dotted lines 1101e and 1101f enters the pupil 1104 to form an image 1101b on the retina. In the same manner, a conical luminous flux group shown by solid lines 1102c and 1102d spreads from the light condensing point 1102a, of which a conical luminous flux group shown by dotted lines 1102e and 1102f enters the pupil 1104 to form an image 1102b on the retina. Also, a conical luminous flux group shown by solid lines 1103c and 1103d spreads from the light condensing point 1103a, of which a conical luminous flux group shown by dotted lines 1103e and 1103f enters the pupil 1104 to form an image 1103b on the retina. As you can see from this figure, the light condensing points are discretely formed, and therefore the images formed on the retina are also discrete. As a result, the stereoscopic image is perceived to be grainy and perceived as a stereoscopic image lacking in smoothness.

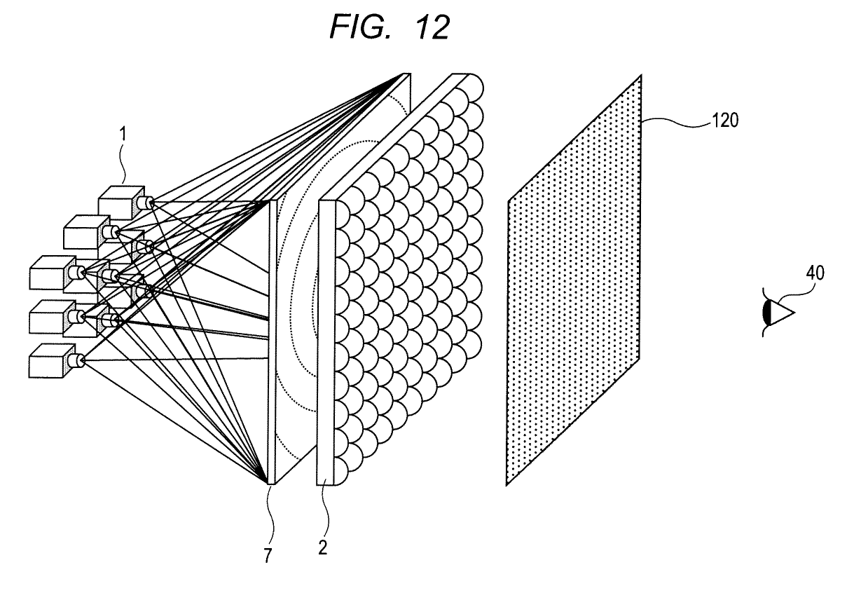

The solution to this problem is to generate luminous flux groups for forming interpolation images between the image 1101b and the image 1102b and between the image 1101b and the image 1103b. More specifically, as shown in FIG. 12, a diffuser 120 for diffusing light beams is placed between the micro lens array 2 and the observer 40.

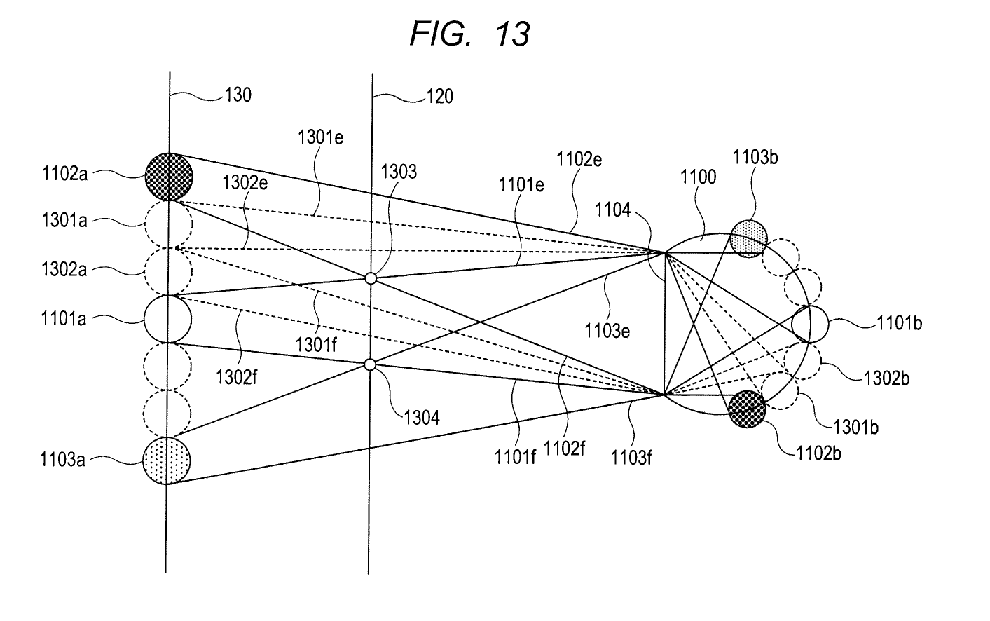

Next, the desirable installation position and diffusion angle of the diffuser 120 will be described by using FIGS. 13 to 16. For ease of explanation, in the same manner as FIG. 11, a description will be provided by using the three points 1101a, 1102a, and 1103a of the nine light condensing points formed with respect to the micro-lens 1105 of the micro-lens array 2.

Firstly, the interpolation of the luminous flux groups will be described by using FIG. 13. FIG. 13 is a diagram based on FIG. 11, where the micro-lens array 2, the micro-lens 1105, and the lines to indicate the whole conical light beams of the respective light condensing points are not illustrated. The light condensing points 1101a, 1102a, and 1103a are placed evenly spaced apart in a focal plane of the micro-lens array 2, that is, a focal plane 130 of a micro-lens group. Also, although not illustrated herein, the light condensing points formed with respect to the adjacent micro-lenses are placed evenly spaced apart following these three points. A conical luminous flux group shown by solid lines 1101e and 1101f spreading from the light condensing point 1101a enters the pupil 1104 to form the image 1101b on the retina. A conical luminous flux group shown by solid lines 1102e and 1102f spreading from the light condensing point 1102a enters the pupil 1104 to form the image 1102b on the retina. A conical luminous flux group shown by solid lines 1103e and 1103f spreading from the light condensing point 1103a enters the pupil 1104 to form the image 1103b on the retina.

As described above, the images formed on the retina are discretely distributed, and as a result, the stereoscopic image is perceived to be grainy. Therefore, luminous flux groups to form on the retina an image 1301b and an image 1302b for the interpolation, for example, between the image 1102b and the image 1101b is produced. The luminous flux group to form the image 1301b on the retina is a conical luminous flux group shown by dotted lines 1301e and 1301f spreading from a virtual light condensing point 1301a that is an imaginary and virtual light condensing point. Also, the luminous flux group to form the image 1302b on the retina is a conical luminous flux group shown by dotted lines 1302e and 1302f spreading from a virtual light condensing point 1302a. These new luminous flux groups are produced by diffusing the luminous flux groups spreading from the real light condensing points with the diffuser 120. Here, a case will be described as an example where the diffuser 120 is placed in a plane passing through an intersection point 1303 between the solid lines 1101e and 1102f, and an intersection point 1304 between the solid lines 1101f and 1103e. This installation position is just an example. Alternatively, the diffuser 120 may be close to the focal plane 130 or the pupil 1104, as described later. However, since the diffuser 120 is placed in order to form virtual light condensing points between the light condensing points arranged in the focal plane 130, the diffuser 120 must be placed more apart from the micro-lens array 2 than the focal plane 130. That is to say, when the distance between the diffuser 120 and the micro-lens array 2 (the plane L2 in FIG. 5) is denoted as L, L>f2 is established. It should be noted that, in the case where the light condensing points are placed evenly spaced apart, when the installation plane of the diffuser 120 is determined as described above, the diffuser 120 and the micro-lens array become parallel.

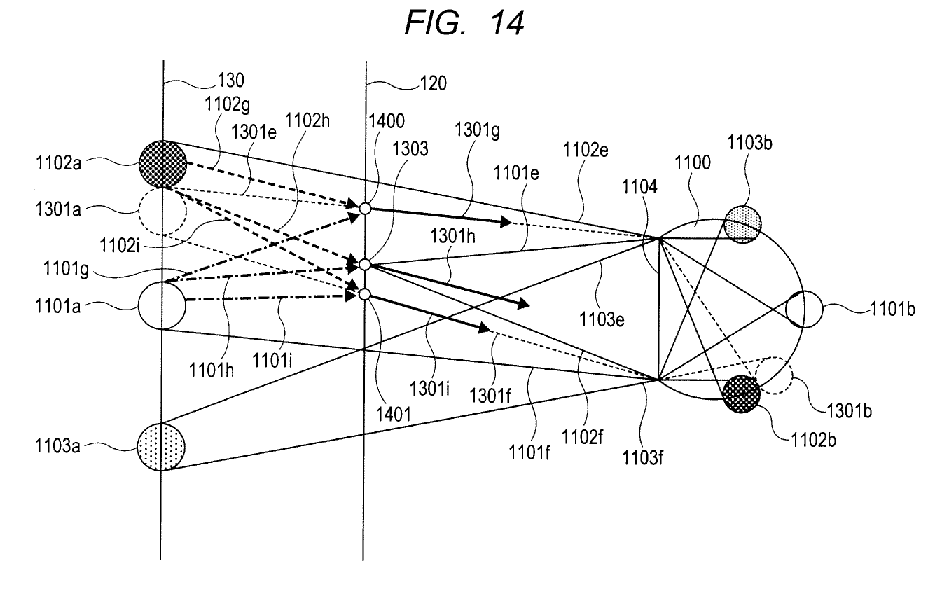

There will be described, by using FIG. 14, the diffusion angle of the diffuser 120 in the case of producing the luminous flux group composed of the dotted lines 1301e and 1301f spreading from the virtual light condensing point 1301a for forming the image 1301b on the retina. The group of pixels forming the image 1301b for the interpolation between the image 1102b and the image 1101b on the retina is set to include a high proportion of the group of pixels forming the image 1102b because the image 1301b is close to the image 1102b. In other words, too much of redundant luminous fluxes are prevented from being included in a desired luminous flux group due to too large a diffusion angle of the diffuser 120. Too large a diffusion angle of the diffuser 120 causes the inclusion of luminous fluxes spreading from many light condensing points, resulting in a lack of sharpness not only in an image, such as the image 1301b, for interpolation to be formed on the retina, but also in, for example, the image 1102b from the real light condensing point 1102a due to overlap with the luminous fluxes from other light condensing points. Therefore, the luminous flux group spreading from the virtual light condensing point 1301a to be described later includes a high proportion of the luminous flux group spreading from the light condensing point 1102a, and includes less luminous flux groups spreading from the light condensing points 1101a and 1103a. Hereinafter, a description will be given by using the principal rays of the respective luminous fluxes. Also, note that the luminous flux spreading from the light condensing point 1103a is disregarded.

First of all, a light beam 1301g in the direction of the dotted line 1301e will be described. A light beam 1102g exiting from the light condensing point 1102a and a light beam 1101g exiting from the light condensing point 1101a are incident on an intersection point 1400 between the light beam 1301g and the diffuser 120. It should be noted that the angular change from the light beam 1102g to the light beam 1301g is smaller than the angular change from the light beam 1101g to the light beam 1301g, and therefore the mixing of the light beam 1101g into the light beam 1301g can be avoided by using the diffuser 120 having the diffusion angle allowing the production of the light beam 1301g from the light beam 1102g. Such a diffusion angle is determined based on the location of the light condensing points by the micro-lens array, the observer's eye location, and the distant and angular relationship between those locations and the location of the diffuser.

With respect to a range between the point 1400 and the point 1303 on the diffuser 120, allowing the entry of the conical luminous flux group shown by the solid lines 1102e and 1102f spreading from the light condensing point 1102a, the angular change relation is the same as the angular changes from the light beam 1102g to the light beam 1301g and from the light beam 1101g to the light beam 1301g. However, with respect to a range between the point 1303 and a point 1401 on the diffuser 120, a greater angular change becomes necessary. The luminous flux groups spreading from plural light condensing points are incident on one portion of the diffuser 120. However, since it is difficult to change the diffusion angle with respect to a specific luminous flux group, it is assumed here that the diffusion angle of the diffuser 120 is uniform. Here, when the diffusion angle is set to a value α suitable for the range between the points 1400 and 1303, the luminous fluxes spreading from the light condensing point 1102a cannot be guided for the interpolation of the image 1301b, in the range between the points 1303 and 1401. In that case, although the interpolation image 1301b is formed on the retina, an image omission of a portion close to the image 1101b occurs. This is because the description is given based on the diffuser in which there is no luminous flux (density) to be diffused when the diffusion value α is exceeded. Actually, the diffusion angle represents, by a total angle, the position where the intensity of a conical diffusion light becomes a half value (half the light density) of the central intensity (light density in the principal ray direction). Even when the diffusion value α is exceeded (even in the range between the points 1303 and 1401), the luminous fluxes from the light condensing point 1102a contribute to the interpolation of the image 1301b although the light density decreases. In the same manner, the luminous fluxes from the light condensing point 1101a also contribute to the interpolation of the image 1301b although the light density decreases. That is to say, the luminous fluxes from the light condensing points 1102a and 1101a are superimposed, and therefore the image 1301b is formed with the pixels of these luminous fluxes superimposed. However, since the diffusion angle is set to the value α suitable for the range between the points 1400 and 1303, the superimposed ratio of the luminous fluxes from the light condensing point 1102a is high, and thus the image 1301b becomes an image close to the image 1102b.

When the diffusion angle is set to a value β (α<β) suitable for the range between the points 1303 and 1401, the superimposed ratio of the luminous fluxes spreading from the light condensing point 1101a increases in portions close to the point 1303 of the range between the points 1303 and 1401 and the range between the points 1400 and 1303.

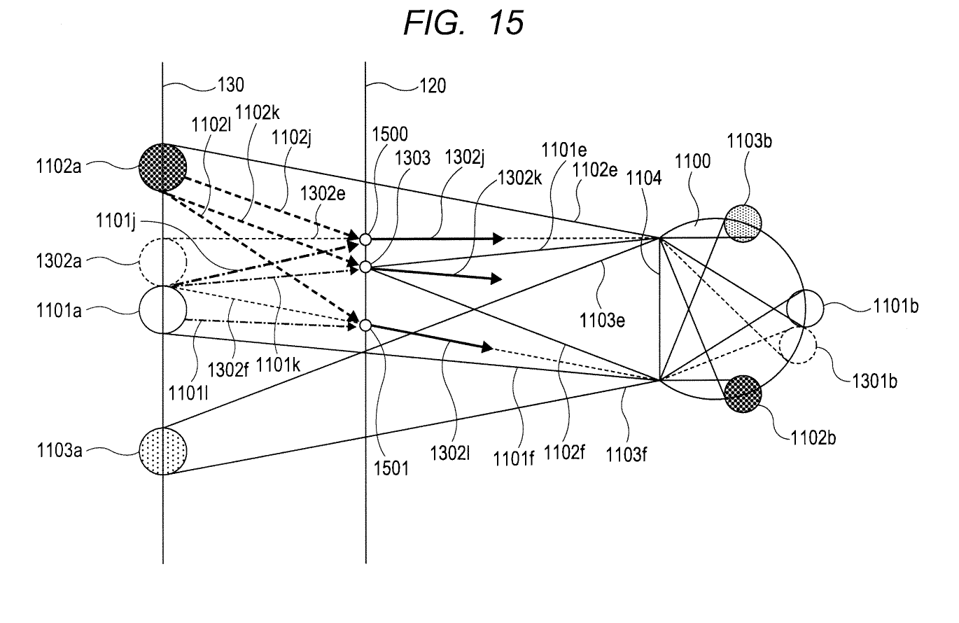

FIG. 15 is a diagram for explaining the diffusion angle of the diffuser 120 in the case of producing the luminous flux group formed by the dotted lines 1302e and 1302f spreading from the virtual light condensing point 1302a to form the image 1302b on the retina. This case is also based on the same concept as FIG. 14. When the diffusion angle is set to a value γ suitable for the range between a point 1501 and the point 1303, the luminous fluxes spreading from the light condensing point 1101a cannot be guided for the interpolation from the range between the point 1303 and a point 1500. Actually, in the same manner as FIG. 14, even when the diffusion value is exceeded, the light beams are diffused although the density decreases. The luminous fluxes from the light condensing points 1101a and 1102a are superimposed, and therefore the image 1302b is formed with the pixels of these luminous fluxes superimposed. However, since the diffusion angle is set to the value γ suitable for the range between the points 1501 and 1303, the superimposed ratio of the luminous fluxes from the light condensing point 1101a is high, and thus the image 1302b becomes an image close to the image 1101b. When the diffusion angle is set to a value δ (γ<δ) suitable for the range between the points 1303 and 1500, the superimposed ratio of the luminous fluxes spreading from the light condensing point 1102a increases in portions close to the point 1303 of the range between the points 1303 and 1500 and the range between the points 1501 and 1303.

As described in FIGS. 14 and 15, the diffuser 120 is disposed between the focal plane of the micro-lens array 2, i.e. the focal plane 130 of the micro-lens group, and the observer's pupil 1104, thereby allowing the interpolation of the image 1302b between the images 1102b and 1101b on the retina. With the interpolated image, when viewed from the observer, the stereoscopic image becomes less likely to be perceived as grainy in image quality, and a smooth stereoscopic image in image quality can be viewed. Also, the stereoscopic image becomes less likely to be perceived as grainy (discrete) in image quality, thereby allowing the observer to see the stereoscopic image having an increased sharp image quality.

It should be noted that with regard to the luminous flux group spreading from the light condensing point 1103a initially disregarded, the incidence angle on the diffuser 120 is large and the luminous flux density within the diffusion angle of the diffuser decreases, and therefore no consideration is required. For the interpolation of the stereoscopic image using the diffuser, it is only necessary to consider the relationship between adjacent light condensing points.

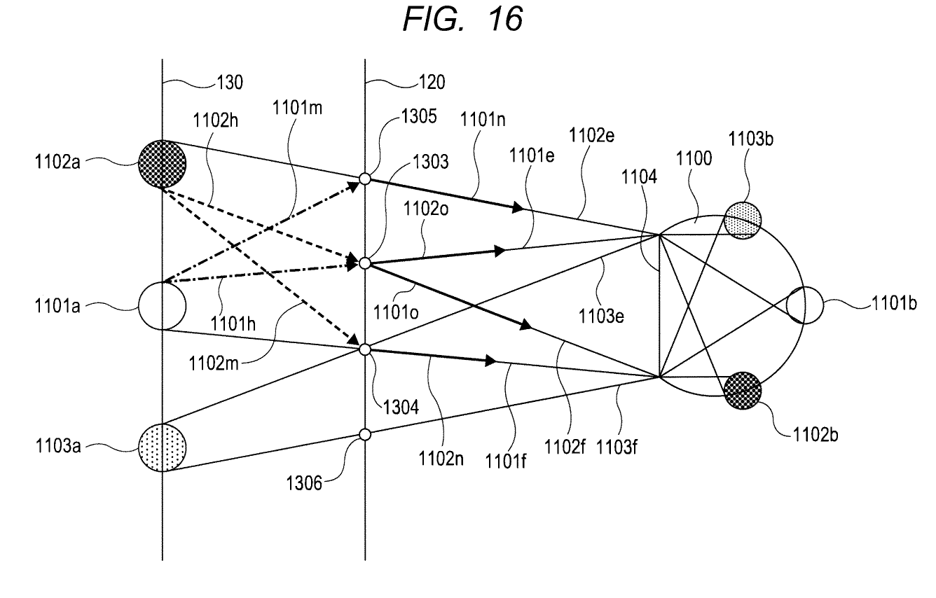

Here, by using FIG. 16, an extreme example in the case of performing the interpolation between the images 1101b and 1102b will be provided. The extreme example is the case where a light beam group to overlap the light beam group spreading from the light condensing point 1102a is produced based on the light beam group spreading from the light condensing point 1101a while a light beam group to overlap the light beam group spreading from the light condensing point 1101a is produced based on the light beam group spreading from the light condensing point 1102a. More specifically, this example uses the diffuser 120 having a diffusion angle ω sufficient to change the angle of a light beam 1101h to a light beam 1101o and the angle of a light beam 1101m to a light beam 1101n, and to change the angle of a light beam 1102h to a light beam 1102o and the angle of a light beam 1102m to a light beam 1102n. In this case, although many mixed pixels are contained in the interpolation image, the interpolation can be reliably performed. Using a diffuser with a diffusion angle larger than the diffusion angle ω results in deterioration of the image quality.

As for the installation location of the diffuser 120, even when the diffuser 120 is placed at locations other than the location described in FIGS. 13 to 16, there is an effect of enhancing the image quality. A smooth stereoscopic image can be obtained by decreasing the diffusion angle when the diffuser is located close to the observer, and increasing the diffusion angle when the diffuser is located away from the observer. That is, the diffusion angle of the diffuser 120 is made to correspond to the distance from the micro-lens array 2. The relationship between the diffusion angle and the distance from the micro-lens array 2 is in inverse proportion. It is because, when the diffuser 120 is located close to the observer, that is, when the diffuser 120 is located away from the focal plane 130 of the micro-lens array 2, less angular variation is required for changing the light beam that is incident on the diffuser from the light condensing point into the light beam that exits from the virtual light condensing point. Therefore, the diffuser with a small diffusion angle is sufficient to attain the above-described purpose. Also, if the diffusion angle remains large, the luminous flux groups from plural light condensing points are excessively mixed, resulting in deterioration of the image quality. On the other hand, when the diffuser 120 is located away from the observer, that is, when the diffuser 120 is located close to the focal plane 130 of the micro-lens array 2, a large angular variation is required for changing the light beam that is incident on the diffuser from the light condensing point into the light beam that exits from the virtual light condensing point. Therefore, it is necessary to use the diffuser with a large diffusion angle to attain the above-described purpose. Also, if the diffusion angle remains small, the light density sufficient to form the interpolation image cannot be obtained.

It should be noted that, as is clear from the above description, it may not be necessary to place the Fresnel lens or a convex lens in the focused plane of the projectors, and, even if such a lens is not provided, a sufficient effect can be obtained.

According to this embodiment, the diffuser is placed between the micro-lens array and the observer, thereby allowing the interpolation of the light beams incident on the observer's eye and allowing a smooth stereoscopic image to be perceived.

What is claimed is:

1. An auto-stereoscopic display comprising: a plurality of projectors; a micro-lens array for condensing light beams of images projected from the projectors; and a diffuser for diffusing the light beams condensed by the micro-lens array.

2. The auto-stereoscopic display according to claim 1, wherein the diffuser has a diffusion angle corresponding to a distance from the micro-lens array.

3. The auto-stereoscopic display according to claim 2, wherein the diffusion angle is inversely proportional to the distance.

4. The auto-stereoscopic display according to claim 1, wherein the diffuser is arranged so as to form a virtual light condensing point between a plurality of condensing points of the light beams condensed by a plurality of micro-lenses constituting the micro-lens array.

5. The auto-stereoscopic display according to claim 4, wherein the diffuser is disposed more apart from the micro-lens array than a focal length of the plurality of micro-lenses constituting the micro-lens array.
